(19) United States
(12) Patent Application Publication
(10) Pub. No.: US 2010/0135858 A1
(43) Pub. Date: Jun. 3, 2010

(54) Ink Composition and Oxygen Indicator

(76) Inventors: Eero Hurme, Tokyo (JP); Thea Sipila Inen-Malm, Tokyo (JP); Anna-Liisa Ruskeepaa, Tokyo (JP); Masahiko Kawashima, Tokyo (JP); Keisuke Kowsaka, Tokyo (JP)

Correspondence Address: STAAS & HALSEY LLP, SUITE 700, 1201 NEW YORK AVENUE, N.W., WASHINGTON, DC, 20005, US

(21) Appl. No.: 11/990,176

(22) PCT Filed: Aug. 7, 2006
(86) PCT No.: PCT/JP2006/315982

§ 371 Date: Feb. 8, 2008

(30) Foreign Application Priority Data
Aug. 9, 2005 (FI) 20050808

(51) Int. Cl. G01J 1/50; B05D 3/00; C09G 1/16; H01B 3/30

(52) U.S. Cl. 422/86; 427/385.5; 524/77; 524/592

(57) ABSTRACT

An ink composition comprising a redox compound as dye, a volatile agent as reducing agent, a polymer material as binder and a volatile solvent, wherein said ink composition has a viscosity of 3 to 150 mPas when said ink composition is used for printing.

### TECHNICAL FIELD

The invention relates to an ink composition, a method for manufacturing an ink composition, an oxygen indicator and a method for manufacturing an oxygen indicator.

### BACKGROUND ART

It is known to use an indicator that changes colour to indicate a change in the conditions of the package to detect a leakage, a change in oxygen content of a package such as a protective gas package or spoilage of the product within it. Many known indicators of this type comprise a redox colour such as methylene blue, an alkaline substance such as calcium hydroxide and a reducing agent such as glucose, which the alkaline substance makes highly reductive. In an oxygen-free environment, the reducing agent reduces the redox indicator well from its ordinarily colourful oxygenized state to its reduced ordinarily colourless form. For example, the oxygenized state of methylene blue, which is blue in colour, reduces with alkaline glucose to a leuco state, which is colourless. Leuco methylene blue easily oxygenizes back to methylene blue under the influence of a strong oxidizing agent such as oxygen. Such indicators should be stored under anaerobic conditions and they are generally very reversible upon reacting with oxygenating agents. They are also generally sensitive to light and their sensitivity is significantly affected by the presence of oxidizing gases, such as carbon dioxide and sulphur dioxide.

In U.S. Pat. No. 4,526,752 is disclosed an oxygen indicator functioning in an anaerobic environment like that described above, this indicator comprising a substrate carrying, in leuco state, a dye free of reducing agent and which reacts irreversibly with oxygen with a color change. The indicator is manufactured by dissolving the dye in water containing a volatile reducing agent and removing the reducing agent in an environment in which there is no air and the package is sealed. The indicator can be set or printed onto the film that closes the package.

A disadvantage of the known oxygen indicator is the viscosity of the ink solution, which is too high for attaching the indicator to the package by the dripping technique.

Further, in this ink composition, a solution is adjusted into a high pH environment by a volatile alkali agent for effectively reducing a dye into a leuco state with a volatile reducing agent. Therefore, the obtained oxygen indicator tends to be poor in resistance to light.

### DISCLOSURE OF THE INVENTION

The object of the invention is to obviate the disadvantages mentioned above.

The object of the invention is to present a new type of oxygen indicator and an ink composition, whose viscosity and adhesion are suitable for printing using the dripping technique. In printing using the dripping technique, the indicator can be attached directly to the packaging material in conjunction with packaging. This enables the manufacture of an individual, product-specific indicator on the packaging line without the disadvantages associated with the handling and storage in an anaerobic state of oxygen indicators manufactured in advance. Additionally, the attaching of the indicator associated with packaging using the dripping technique enables the use of the indicator as an identifier for individualizing the package. Further, the object of the invention is to present an oxygen indicator and an ink composition that is well suited for use in packages containing carbon dioxide, which is one of the most important gases in foodstuffs packages.

The object of the present invention is to further provide an ink composition excellent in resistance to light of a fluorescent lamp and the like.

1. An ink composition comprising a redox compound as dye, a volatile agent as reducing agent, a polymer material as binder and a volatile solvent, wherein said ink composition has a viscosity of 3 to 150 mPas when said ink composition is used for printing.

2. A composition according to item (1) having a viscosity of 10 to 40 mPas when it is used for printing.

3. An ink composition according to item (1) wherein the binder content is 10 to 50 wt % based on the ink composition.

4. The ink composition according to item (1) wherein the binder has a weight average molecular weight of 8000 or less.

5. A composition according to any one of items (1) to (4) wherein the binder is selected from the group consisting of a polyol, a ketone resin, a cellulose derivative and polyvinylpyrolidone.

6. An ink composition according to any one of items (1) to (4) wherein the binder comprises a cyclohexanone-derived ketone resin or an acetophenone-derived ketone resin.

7. An ink composition according to any one of items (1) to (4) wherein the binder comprises a mixture of a ketone resin, a resin acid and an ester compound from an alcohol.

8. An ink composition according to item (7) wherein the resin acid is aleuretic acid, jalaric acid or laccijalaric acid.

9. A composition according to any one of item (1) to (4) wherein the volatile reducing agent is selected from the group consisting of an alcohol, ammonia, a thiol, an aldehyde and a low molecular amine.

10. An ink composition according to any one of items (1) to (4) wherein the volatile reducing agent is ammonia.

11. A composition according to any one of items (1) and (4) wherein the solvent is selected from the group consisting of an alcohol, a ketone, an ester and water.

12. An ink composition according to any one of items (1) to (4) wherein the redox agent as dye has a redox potential of 0.1 V or more.

13. A method for manufacturing an ink composition comprising mixing a redox agent as dye, a polymer material as binder and a volatile solvent, and then adding a volatile agent as reducing material to the resultant mixture and reducing the dye.

14. An oxygen indicator prepared by dripping the ink composition according to any one of items (1) to (12).

15. A method for manufacturing an oxygen indicator using dripping technique comprising dripping the ink composition according to any one of items (1) to (12), and then removing the volatile reducing agent and the volatile solvent.

16. An oxygen indicator according to item (14) indicating a leakage and/or a change in oxygen content by color change.

### BEST MODE FOR CARRYING OUT THE INVENTION

An ink composition according to the invention comprises a redox agent (compound) as dye, a volatile substance (agent) as reducing agent, a polymer material as binder and volatile solvent.

The binder for use in the present invention plays a role of mainly including a redox agent as dye in the binder in a dispersed state and fixing the dye on a deposition surface. Materials for the binder may be used alone or as a mixture thereof as long as the binder is a binder that is commonly used. In the case of dripping onto the plastic surface, the content of the binder in the ink composition in the present invention is preferably 10 to 50 wt % based on the total amount of ink composition in terms of the property of binding to a plastic as a deposition surface, the performance of discharge of an ink solution from a print head and plugging of a nozzle hole. The content is more preferably 15 to 45 wt %. The binding property of the deposition surface may be improved by performing a well known surface treatment such as a corona treatment. The viscosity of the ink composition in printing by a dripping technique is preferably 3 to 150 mPa*s at 30° C., more preferably 10 to 40 mPa*s in terms clear printing. For achieving this solution viscosity, the smaller the weight average molecular weight (Mw) of the binder, the more preferable, but in view of elution of binder components, the weight average molecular weight is preferably 1000 to 8000, the weight average molecular weight is more preferably 1500 to 7000, and the weight average molecular weight is further preferably 2000 to 6000.

Binders for use in the present invention include for example, ketone resins, cellulose derivatives (cellulose esters such as nitrocellulose, cellulose ethers such as hydroxyethyl cellulose and modified celluloses such as oxycellulose), polyvinyl alcohol, polyols, polyvinyl pyrolidone, and polyamide, polyacetal and other natural resin binders, and denatured products thereof, and these may be used alone or as a mixture thereof according to the surface material of a printed matter or a coated matter.

The binder is preferably a ketone resin in terms of the reduction support function of a dye, preferably a cellulose derivative, a natural resin or the like in terms of the color change reactivity of a dye, and preferably a natural resin or the like in terms of safety, and more preferably a ketone resin and a natural resin with all these things considered.

When the printed surface is a plastic, the concentration of the binder is 10 wt % or more for a print area to form a uniform surface, but use of a binder containing a ketone resin is more preferable because the aforementioned low viscosity and binder concentration can be made compatible with each other. Further, when a binder containing a ketone resin is used, the dye can be reduced into a leuco state with a small amount of ammonia as a reducing agent and pH of an ink solution can be set to be close to neutral pH, and therefore the storage stability of the ink composition and the light resistance of the printed matter are excellent and in addition, the influence of a volatile material scattered into a package after packaging can be minimized.

Ketone resins for use in the present invention are compounds obtained by a condensation reaction of a compound having a ketone group and an aldehyde, and include, for example, a methyl ethyl ketone, methyl isobutyl ketone, methyl cyclohexanone, cyclohexanone and acetophenone resins, and the ketone resin may be selected from the aforementioned types of resins and used. Preferable are cyclohexanone and acetophenone resins, and cyclohexanone ketone resins include, for example, ketone resins consisting of cyclohexanone and formaldehyde, and acetophenone ketone resins include, for example, ketone resins consisting of acetophenone and formaldehyde.

The added amount of ketone resin relative to the amount of ink composition is preferably 10 wt % or more, more preferably 15 wt % or more in terms of the binder function and the function of reducing the redox agent as dye.

When the ketone resin is used as a binder, a binder having a good oxygen permeability is preferably mixed in terms of control of a coloring rate of the redox agent as dye. Typically, the ketone resin has a moderate oxygen permeability due to intramolecular and intermolecular hydrogen bonds. When the ink composition of the present invention is used in an oxygen indicator, the coloring of the redox agent as dye results from a reaction with oxygen diffusing through the inside of the binder, and a binder having an excellent oxygen permeability may be mixed for the purpose of improving the oxygen diffusibility for promptly detecting a change in environment within the package. For example, the binders include the above described cellulose derivatives, and natural resin binders and denatured products thereof in terms of improvement of the binder functionality and oxygen diffusibility in the binder, but particularly, preferable are natural shellac resins in terms of compatibility with a solvent, the ink viscosity and food safety. The shellac resin is a binder consisting of a resin acid and an ester compound of an alcohol, but more preferable is an ester compound wherein the resin acid of the binder includes aleuretic acid, jalaric acid or laccijalaric acid.

The solvent used in an ink composition according to the invention is intended to make the structure of the ink composition more homogenous and leave the ink composition. As the solvent, there can be used a volatile solvent such as a volatile alcohol, ketone, ester, water and/or any similar volatile solvent dissolving dye and binder of the composition. Preferably, a volatile alcohol such as methanol, ethanol, isopropanol, metoxyethanol and/or their mixtures, more preferably isopropanol, is used as the solvent.

Particularly, a solvent containing water is preferable in terms of use in the form of ammonia water and the solubility of a dye, and a mixture of water and an alcohol is more preferable in terms of the solubility of the binder, the preventability of plugging of a printer head and the drying characteristic after printing.

In an ink composition according to the invention, the reducing agent used as the redox material is intended to reduce the dye and leave the ink composition. As the redox material, there can be used a volatile reducing agent which evaporates and/or is caused to evaporate under printing and/or packaging conditions. Printing using the dripping technique can be implemented under packaging conditions and in a packaging environment. The pressure of the vapour of a volatile reducing agent is at a temperature of 20° C. more than 1 hPa, preferably more than 5 hPa. The volatile reducing agent may be alcohol, ammonia, thiol, aldehyde, a low molecular amine and/or any other comparably functioning reducing agent.

The added amount of reducing agent is preferably 0.1 to 20 wt % of the amount of ink solution, more preferably 0.3 to 15 wt %, further preferably 0.3 to 13 wt %, in terms of the reducing capability.

When the reducing agent is ammonia, the binder is preferably a combination with a ketone resin in terms of the reactivity of a decoloring reaction for bringing a dye into a leuco state.

When the reducing agent is ammonia, the reducing agent is typically added in the form of ammonia water, and the added amount of reducing agent relative to the amount of ink solution is preferably 0.1 to 20 wt %, more preferably 0.3 to 15 wt % in terms of the solubility of the binder in water and the reducing capability if 25% aqueous ammonia solution is used.

Further, by appropriately adjusting the ratio of the content of ammonia water as a reducing agent to the content of the ketone resin as a binder, the pH of the ink solution can be adjusted, and by taking advantage of a phase transition function of the binder at the time of forming a coated film, the coated surface can be controlled to be transparent or opaque. Similarly, performing dye reduction with the pH of the ink solution made closer to neutral pH (about pH 10 or less) than the value in the conventional technique (pH 10.5 or more), the light resistant function can considerably be improved.

The redox agent as dye according to the present invention refers to an agent changing its color with an environmental change such as redox associated with pH, temperature, exchange of hydrogen and electrons or direct oxidation with oxygen. The redox agent may be any material as long as oxidation or reduction of the material causes a shift in light absorption wavelength. Presence/absence of oxygen can be determined by detecting the light absorption wavelength thus shifted. For the range of available light absorption wavelengths, any wavelength may be used as long as the shifted wavelength can be measured or detected.

The reaction shifting light absorption wavelength for the redox agent means in the present invention that the structure of the indicator itself changes, or in the case of the redox agent, the light absorption wavelength is shifted by a reaction with another compound which the redox agent contains in an oxygen indicating part. By selecting variously indicators for use in the present invention, the color after coating, the detected oxygen concentration, the color changing rate and the like can appropriately be set. Further, when the color change by an indicator for use in the present invention is an irreversible reaction, the level of exposure by the oxygen concentration of contents in the package can be determined with a color difference (shade of color, change in color, etc.), thus making it possible to estimate and display how contents in the package have been exposed by the oxygen concentration. Further, when for example, several redox agents utterly different in oxygen concentration required a reaction of the redox agent, reaction rate and color during the reaction are mixed and used if the reaction of the indicator is chemically stable when several indicators are mixed and the reaction is independent, the color can be changed stepwise according to the oxygen concentration, for example orange at a certain oxygen concentration and blue at a higher oxygen concentration, or the color can be changed stepwise according to the oxygen exposure time, for example brown when the time of exposure to the oxygen concentration is short, and red when the time of exposure to oxygen is long.

The redox agents according to the present invention include thiazines, oxazolines, lactones, sultones, azo agents, indigoids, anthraquinones, triphenyl methanes, phenanthroline derivatives, mixtures thereof and the like, and more preferable are thiazines, oxazolines, lactones, sultones, indigoids, anthraquinones, triphenyl methanes and mixtures thereof. Specifically, they include indigotetrasulfonic acid, diphenylamine, diphenylbenzidine, diphenylamine sulfonic acid, ferroin, nitroferroin, methylferroin, dimethylferroin, methylene blue, gallocyanine, methyl red, methyl violet, thymol blue, anthocyanine, methyl yellow, phenol red, thymolphthalein, azaline yellow, anthraquinone, safranin, phenosafranin, β-carotin, lycopene, resolfin, thionin, cresyl blue, toluidine blue, methyl orange, litmus, bromthymol blue, carmine, phenolphthalein, brilliant blue, fast green, indigocarmine, amino black, 1,10-phenathroline, 1,7-phenathroline, 5-phenyl-1,10-phenathroline and 4,7-dimethyl-1,10-phenathroline, N-phenylanthraline acid, nile blue (sulphate), neutral red, diphenylamine-4-sulphone acid, 2,2′-bipyridine, 2,6-dichlorophenolindophenol, 3,3′-dimethylnaphtidine, N,N-dimethyl-1,4-phenylene-diammonium, diphenylamine, diphenylbenzidine and the like. Preferable are indigotetrasulfonic acid, diphenylamine, diphenylbenzidine, diphenylamine sulfonic acid, ferroin, nitroferroin, methylferroin, dimethylferroin, methylene blue, gallocyanine, methyl red, methyl violet, thymol blue, anthocyanine, methyl yellow, phenol red, thymolphthalein, azaline yellow, safranin, phenosafranin, resolfin, thionin, toluidine blue, methyl orange, litmus, bromthymol blue, brilliant blue, fast green, indigocarmine, amino black and 2,6-dichlorophenolindophenol, and more preferable are indigotetrasulfonic acid, diphenylamine sulfonic acid, ferroin, nitroferroin, methylferroin, dimethylferroin, methylene blue, methyl violet, thymol blue, anthocyanine, phenol red, thymolphthalein, azaline yellow, safranin, phenosafranin, resolfin, thionin, toluidine blue, methyl orange, litmus, bromthymol blue, brilliant blue, fast green, indigocarmine, amino black and 2,6-dichlorophenolindophenol, and further preferable are indigotetrasulfonic acid, diphenylamine sulfonic acid, ferroin, nitroferroin, methylferroin, dimethylferroin, methylene blue, thymol blue, thymolphthalein, safranin, phenosafranin, thionin, toluidine blue, litmus, bromthymol blue, brilliant blue, fast green and 2,6-dichlorophenolindophenol. Further more preferable are food dyes, which include brilliant blue, first green, indigocarmine, amino black and the like.

Typically, the added amount of the dye relative to the amount of ink solution is preferably 0.1 to 5 wt %, more preferably 0.3 to 4 wt %, further preferably 0.3 to 3 wt % in terms of the solubility in the solvent and perception of the color difference.

When the redox agent as dye for use in the present invention has a specific redox potential, the content of oxygen in the package can be detected in a desired concentration by using redox agents as dye having different redox potentials. The redox potential according to the present invention is given by a value measured by cyclic voltammetry described later. When the redox potential is 0.1 V or more and +0.7 V or less, the redox agent as dye is promptly changed into an oxidized state by a very small amount of oxygen if the redox agent as dye is brought into a reduced state by a volatile reducing agent, and therefore presence/absence of a very small amount of oxygen can be detected. When the redox potential is less than 0.1 V, the color before the coloring by oxygen exposure can freely be changed, thus making it possible to exhibit an effect of visually enhancing the coloring by oxygen exposure. Further, when the redox potential is 0.7 V or more, the agent can be used as an oxygen indicator if an oxygen supplement material such as deoxidizer does not exist in the package, and in addition, the content of oxide in the package can be detected in a desired concentration depending on the value of the redox potential, thus making it possible to achieve a dye of an oxygen detecting ink composition changing its color with a desired oxygen content by the value of the redox potential.

An ink composition according to the invention can additionally contain additives generally used in ink compositions and indicators such as a pH regulating agent, humidity maintainer, enzyme, plasticizing agent, wax, oxygen absorbent and/or commercial lacquers. The pH regulating agent may be a reducing sugar, an organic acid such as ascorbine acid and citric acid as well as sodium ascorbate, sodium sulphite, sodium bisulphite, sodium disulphite, sodium pyrophosphate, calcium ascorbate, dithionite, an inorganic base such as sodium hydroxide, calcium hydroxide, metal powders such as iron and zinc, metal salts such as many iron compounds. The humidity maintainer may be polyethylene glycol, glycerol, propylene glycol, sorbitol and erythritol. The enzyme may be laccase, glucose oxydase and peroxydase. The ink composition and indicator may if needed also contain a substrate and/or an oxygen absorbent. Appropriate substrates are mainly when using enzymes a typical substrate to each enzyme. Possible oxygen absorbents are described, for example, in patent FI 94802.

The ink composition is manufactured by mixing a redox, substance and reducing agent and a polymer material in a volatile solvent and thereafter adding to the mixture a volatile reducing agent. The reducing agent reduces the dye if necessary. The manufacturing process uses conventional dye manufacturing/mixing techniques.

The oxygen indicator is manufactured by printing the ink composition using the dripping technique on the packaging material and removing the volatile reducing agent that reduced the ink and the volatile solvent. Manufacture of the indicator and removal of the reducing agent occurs under oxygen-free conditions, for example, in a vacuum, in a nitrogen, carbon dioxide and/or argon atmosphere. The reducing agent and solvent are usually removed by evaporating. The package can be sealed in connection with printing, ie attachment of the indicator such, that the sealed package remains oxygen-free. The ink composition can be printed using any printing technique based on the dripping technique such as, for example, the ink jet technique or, for example, using the electrostatic technique. The indicator is manufactured and attached to the packaging material preferably using the ink jet technique, which is based on a continuous, piezoelectric or thermal inkjet printing.

The packaging material used may be fiber-, plastic- and/or glass-based and/or any other generally used packaging material. A fiber-based material can be, for example, surface-treated or untreated paper, cardboard, dissolving fiber-based film material or other cellulose-based or polyacetate-based material, for example, cellulose acetate-based material. Plastic material can be, for example, polyethene, polypropene, other polyolefin, polyester, polystyrene, polyamide or any other plastic material generally used as packaging material. Further, the packaging material can be formed from a laminate or other composite material of previously mentioned or other known packaging materials. The packaging material can also be coated.

The oxygen indicator can additionally be protected from oxygen by attaching to it a shield, which is manufactured of a material that is only slightly permeable or impermeable to the oxidizing agent such as PET, EVOH, PVDC, or regenerated cellulose.

The oxygen indicator attached to the package reacts to oxygen coming from outside the package, indicating by a color change of the package. Additionally, the indicator reacts to oxygen that has gotten into the package through breakage of the package, indicating a leakage. The color change can be detected in the wavelength area of visible light 400-780 nm or in the wavelength area of UV radiation 100-400 nm.

When an indicator is used in conjunction with a barcode identification, air that has gotten in due to ageing and/or breakage of the package causes a color change, which ultimately inactivates the identification, it makes reading and/or recognition of the identification impossible. This prevents, for example, a store from selling an aged/or broken package.

The invention enables the attachment of a reliable, irreversible indicator by the dripping technique to a package. An ink composition/indicator according to the invention attaches and remains on very glossy, non-absorbent surfaces such as plastic surfaces. Further, an advantage of an indicator according to the invention is its suitability also for packages using carbon dioxide as a protective gas. Additionally, the components of an ink composition and indicator according to the invention are inexpensive.

The ink composition of the present invention may be used in any field in which the function of the present invention can be used. Such application sectors include food sectors, nonfood sectors, medical sectors, metal sectors (including metal processing sectors), electronic device sectors (including electronic parts sectors) and the like, the ink composition is used for packaging, distribution, storage, quality control and the like in those sectors, and specific examples of applications thereof include oxygen indicators in the packaging in food sectors.

In the following the invention is described in detail with the aid of embodiment examples.

### EXAMPLES

(1) Measurement of Viscosity

The viscosity of each ink composition was measured at 30° C. using a viscometer DV-III manufactured by Brooks Corporation.

(2) Oxygen Permeability

The measurement was carried out in accordance with ASTM-D-3985. Using an oxygen permeation measuring apparatus OX-TRAN manufactured by MOCON Inc., the measurement was carried out under a drying condition at 20° C. with the coated surface set on the oxygen side. A measurement sample was prepared by coating an ink composition on a polyethylene film (PE: thickness of 20 μm) subjected to a corona treatment with a surface treatment of 38 mN/m using a Mayor bar so that the coating thickness was 2.5 μm (dry).

(3) Measurement of Redox Potential

The redox potential in a 1 wt % aqueous solution of each dye was measured using Cyclic Voltammetry HX-105 (trade name) manufactured by HOKUTO DENKO Co., Ltd. For the measurement, a silver/chloride silver electrode was used under an environment of 20° C. A sweep was made from −0.5 V to 1.5 V at a sweep rate of 50 mV/s. For the redox potential, a peak value was used, and a value on the lower current side was used when there were redox potentials at several locations.

(4) Adjustment of Package

(4-1) Main Body: A package (size of the container: 75 mm×75 m×35 mm) obtained by molding a film obtained by dry-laminating a co-extrusion film (50 μm) of linear low density polyethylene (LLDPE)/nylon (NY)/saponified vinyl acetate copolymer (saponification degree: 38%) (EVOH)/NY to a polypropylene (PP) filler containing sheet (500 μm) was used.

(4-2) Top Seal Film: A film obtained by dry-laminating a co-extrusion film (50 μm) of LLDPE/NY/EVOH/NY to a polyethylene (PE) film (50 μm) was used, and the film was subjected to a corona treatment with the surface of the PE film as an inner surface (corona treatment: 38 m/N).

(4-3) Packaging Procedure: Each ink composition was printed on the inner surface (corona treatment surface) of the top seal film by an inkjet printer APOLLO-II (trade name) manufactured by SPECTRA Inc., the inside of the container was directly evacuated and subjected to gas flush by a vacuum gas flush packaging machine DYNAPACK 462 (trade name), and the package was heat-sealed to prepare a sealed package.

(5) Measurement of Composition Ratio of Oxygen and Carbon Dioxide in Space within Packaging Container for Sealing

The composition ratio (wt %) of oxygen and carbon dioxide in a space within a packaging container for sealing at 20° C. was measured using an oxygen and carbon dioxide measurement device Combi Check (trade name) manufactured by PBI Dansensor. The nitrogen concentration was calculated by subtracting the oxygen concentration and the carbon dioxide concentration from 100 wt %.

(6) Measurement of Coloring Time

A photograph was taken every 30 minutes in a room controlled to 20° C., the colors of the photographs were compared, and a measurement was made at a point where the color no longer changed.

(7) Measurement of Resistance to light

In a room controlled to 20° C., a sample was left standing in a state of 600 luxes using a fluorescent lamp, a photograph was taken once every day, the colors of the photographs were compared, and a measurement was made at a point where the color acme to fade.

(8) Method for Preparing Ink Composition

The dye(s) and binder(s) shown in Table 1 were dissolved in a mixed solvent of water and an alcohol, and after they were dissolved, the solution was sealed, a reducing agent was added, and the resultant mixture was stirred. Before addition of the reducing agent, the dye was in a coloring state, but after addition of the reducing agent, the dye was reduced within a day to give a colorless ink solution.

(9) Resin and Reagent Used

Ketone Resin: Ketone resin (condensate of cyclohexanone and formaldehyde) Krumbhaar 1717 (trade name).

Natural Resin: Natural resin (shellac resin is an ester compound of a resin acid and an alcohol) White Shellac GBN-D (trade name) manufactured by Gifu Shellac Corporation.

Nitrocellulose Resin: Nitrocellulose resin manufactured by Akzo Novel.

Methylcellulose Resin: Methylcellulose resin manufactured by Akzo Novel.

Reduced Sugar: D(+)-glucose manufactured by Kanto Chemical Co., Inc.

For other chemical materials, chemical materials manufactured by Kanto Chemical Co., Inc. were used.

### Examples 1 to 11

The ink composition prepared by the above method with the components described in Table 1 was placed in an ink reserve tank of the inkjet printer manufactured by SPECTRA INC., the temperature of a printer head of the printer was elevated to 30° C., printing was performed on the PE surface (corona treatment surface) as the package inner surface of the top seal film, the printed film was used as the top seal film, the inside of the container was directly evacuated and subjected to gas flush by the vacuum gas flush packaging machine DYNAPACK 462, and the package was heat-sealed to prepare a sealed package. Ink compositions and conditions for preparation of the sample are described in Tables 1 and 3. Examples 1 to 10 were all good in printed quantity and resistance to light. Example 11 had a higher viscosity and therefore had a little unevenness in the evaluation of inkjet printing although it would cause no problem from a practical standpoint. In example 11, the pH of the ink solution was 10 to 11, and therefore the color tended to fade within a week in the test of resistance to light under a fluorescent lamp.

### Comparative Example 1

The indicator disclosed in U.S. Pat. No. 4,526,752 was prepared. As shown in Table 1, it was necessary to adjust the pH of the ink solution to be 10 to 11 using a reducing alkali agent for reducing (decoloring) a leuco dye in comparative example 1. In the ink composition prepared using 5 wt % of methyl cellulose typically used, the viscosity of the ink solution was 300 mPa*s. In this range of viscosity, it was impossible to perform piezo inkjet printing as a dripping technique (because the ink solution was not discharged from a nozzle). When performing hand coating with the ink composition prepared using 5 wt % of methylcellulose, a uniform coated film could not obtained with a polyethylene plastic film subjected to a corona treatment.

The invention is not only limited to the embodiment examples presented above, but many variations are possible within the scope of the inventive idea or concept defined by the claims.

TABLE 1

| | | Example 1 | Example 2 | Example 3 |
|---|---|---|---|---|
| pH of ink solution | | pH = 6-7 | pH = 6-7 | pH = 6-7 |
| constitution | leuco dye | methylene blue | methylene blue | 2,6-dichloroindophenol |
| | redox potential | +0.5 V | +0.5 V | +0.7 V |
| | | 0.16 g | 0.16 g | 0.2 g |
| | other dyes | not present | not present | not present |
| | redox potential | | | |
| | binder | ketone resin | ketone resin | ketone resin |
| | | (Krumbhaar | (Krumbhaar | (Krumbhaar |
| | | K1717) | K1717) | K1717) |
| | | Mw = 3400 | Mw = 3400 | Mw = 3400 |
| | | 2.15 g | 4 g | 2.15 g |
| | content of binder (relative to | 20.4 | 37.9 | 20.4 |
| | the amount of ink solution) | | | |
| | volatile reducing agent | ammonia | ammonia | ammonia |
| | | 25% aqueous solution | 25% aqueous solution | 25% aqueous solution |
| | | 1 ml | 1 ml | 1 ml |
| | solvent isopropanol | 6 ml | 6 ml | 6 ml |
| | water | 1.25 ml | 1.25 ml | 1.25 ml |
| | viscosity of ink composition | 30 | 60 | 30 |
| | @30° C. | | | |
| | mPa · s | | | |
| | coating thickness (μm) | 2.5 | 2.5 | 2.5 |
| printing conditions | temperature of printer head | 30° C. | 30° C. | 30° C. |
| packaging conditions | gas composition | | | |
| | oxygen | 0% | 0% | 0% |
| | carbon dioxide | 0% | 0% | 0% |
| | nitrogen | 100% | 100% | 100% |
| | deoxidant | present | present | present |
| | (Wonder Keep RP200) | | | |
| results | printed quantity | good | good (a little uneven) | good |
| | | | (practical level) | |
| | gas composition in package | | | |
| | (after one week) | | | |
| | oxygen | 0.0% | 0.0% | 0.0% |
| | carbon dioxide | 0.1% | 0.1% | 0.1% |
| | nitrogen | 99.9% | 99.9% | 99.9% |
| | oxygen permeability of | 80 | 80 | 80 |
| | binder | | | |
| | O2T Runder dry condition at | | | |
| | 23° C. | | | |
| | ml/atm/24r/m2 | | | |
| | color of oxygen indicator | transparent | transparent | transparent |
| | (just after preparation) | | | |
| | color of oxygen indicator | transparent | transparent | transparent |
| | (after one week) | | | |
| | coloring time after release to | 8 hours | 5 hours | 8 hours |
| | air | | | |
| | color at the time of coloring | blue | blue | blue |
| | light resistance test | three months or longer | three months or longer | three months or longer |
| | (fluorescent lamp 600 luxes, | | | |
| | 20° C.) | | | |

| | | Example 4 | Example 5 | Example 6 |
|---|---|---|---|---|
| pH of ink solution | | pH = 7-9 | pH = 7-9 | pH = 7-9 |
| constitution | leuco dye | methylene blue | methylene blue | methylene blue |
| | redox potential | +0.5 V | +0.5 V | +0.5 V |
| | | 0.16 g | 0.16 g | 0.16 g |
| | other dyes | not present | safranin | safranin |
| | redox potential | | 0.0 V | 0.0 V |
| | | | 0.05 g | 0.05 g |
| | binder | ketone resin | ketone resin | ketone resin |
| | | (Krumbhaar | (Krumbhaar | (Arakawa Chemical K- |
| | | K1717) | K1717) | 90) |
| | | Mw = 3400 | Mw = 3400 | Mw = 4500 |
| | | 1 g | 1 g | 0.5 g |
| | | shellac resin | shellac resin | shellac resin |
| | | (Gifu Shellac | (Gifu Shellac | (Gifu Shellac |
| | | GBN-D) | GBN-D) | GBN-D) |
| | | Mw = 7000 | Mw = 7000 | Mw = 7000 |
| | | 1.15 g | 1.15 g | 1.15 g |
| | content of binder (relative to the | 20.4 | 20.4 | 20.4 |
| | amount of ink solution) | | | |
| | volatile reducing agent | ammonia | ammonia | ammonia |
| | | 25% aqueous solution | 25% aqueous solution | 25% aqueous solution |
| | | 1 ml | 1 ml | 1 ml |
| | solvent isopropanol | 6 ml | 6 ml | 6 ml |
| | water | 1.25 ml | 1.25 ml | 1.25 ml |
| | viscosity of ink composition | 30 | 30 | 30 |
| | @30° C. | | | |
| | mPa · s | | | |
| | coating thickness (μm) | 2.5 | 2.5 | 2.5 |
| printing conditions | temperature of printer head | 30° C. | 30° C. | 30° C. |
| packaging conditions | gas composition | | | |
| | oxygen | 0% | 0% | 0% |
| | carbon dioxide | 0% | 0% | 0% |
| | nitrogen | 100% | 100% | 100% |
| | deoxidant | present | present | present |
| | (Wonder Keep RP200) | | | |
| results | printed quantity | good | good | good |
| | gas composition in package | | | |
| | (after one week) | | | |
| | oxygen | 0.0% | 0.0% | 0.0% |
| | carbon dioxide | 0.1% | 0.1% | 0.1% |
| | nitrogen | 99.9% | 99.9% | 99.9% |
| | oxygen permeability of binder | 1000 | 1000 | 1000 |
| | O2TRunder dry condition at | | | |
| | 23° C. | | | |
| | ml/atm/24r/m2 | | | |
| | color of oxygen indicator | transparent | red | red |
| | (just after preparation) | | | |
| | color of oxygen indicator | transparent | red | red |
| | (after one week) | | | |
| | coloring time after release to air | 4 hours | 4 hours | 4 hours |
| | color at the time of coloring | blue | blue | blue |
| | light resistance test | three months or longer | three months or longer | three months or longer |
| | (fluorescent lamp 600 luxes, | | | |
| | 20° C.) | | | |

| | | Example 7 | Example 8 | Example 9 | Example 10 |
|---|---|---|---|---|---|
| pH of ink solution | | pH = 7-9 | pH = 7-9 | pH = 7-9 | pH = 7-9 |
| constitution | leuco dye | methylene blue | amino black | brilliant blue | indigocarmine |
| | redox potential | +0.5 V | +1.0 V | +1.2 V | −0.1 V |
| | | 0.16 g | 0.16 g | 0.23 g | 0.23 g |
| | other dyes | safranin | safranin | safranin | safranin |
| | redox potential | 0.0 V | 0.0 V | 0.0 V | 0.0 V |
| | | 0.05 g | 0.05 g | 0.05 g | 0.05 g |
| | binder | ketone resin | ketone resin | ketone resin | ketone resin |
| | | (Krumbhaar | (Krumbhaar | (Krumbhaar | (Krumbhaar |
| | | K1717) | K1717) | K1717) | K1717) |
| | | Mw = 3400 | Mw = 3400 | Mw = 3400 | Mw = 3400 |
| | | 1 g | 1 g | 1 g | 1 g |
| | | shellac resin | shellac resin | shellac resin | shellac resin |
| | | (Gifu Shellac | (Gifu Shellac | (Gifu Shellac | (Gifu Shellac |
| | | GBN-D) | GBN-D) | GBN-D) | GBN-D) |
| | | Mw = 7000 | Mw = 7000 | Mw = 7000 | Mw = 7000 |
| | | 1.15 g | 1.15 g | 1.15 g | 1.15 g |
| | content of binder (relative to | 20.4 | 20.4 | 20.4 | 20.4 |
| | the amount of ink solution) | | | | |
| | volatile reducing agent | ammonia | ammonia | ammonia | ammonia |
| | | 25% aqueous | 25% aqueous | 25% aqueous | 25% aqueous solution |
| | | solution 1 ml | solution 1 ml | solution 1 ml | 1 ml |
| | solvent isopropanol | 6 ml | 6 ml | 6 ml | 6 ml |
| | water | 1.25 ml | 1.25 ml | 1.25 ml | 1.25 ml |
| | viscosity of ink composition | 30 | 30 | 30 | 30 |
| | @30° C. | | | | |
| | mPa · s | | | | |
| | coating thickness (μm) | 2.5 | 2.5 | 2.5 | 2.5 |
| printing conditions | temperature of printer head | 30° C. | 30° C. | 30° C. | 30° C. |
| packaging | gas composition | | | | |
| conditions | oxygen | 0% | 0% | 0% | 0% |
| | carbon dioxide | 50% | 50% | 50% | 50% |
| | nitrogen | 50% | 50% | 50% | 50% |
| | deoxidant | present | not present | not present | present |
| | (Wonder Keep RP200) | | | | |
| results | printed quantity | good | good | good | good |
| | gas composition in package | | | | |
| | (after one week) | | | | |
| | oxygen | 0.0% | 0.0% | 0.0% | 0.0% |
| | carbon dioxide | 50.0% | 50.0% | 50.0% | 50.0% |
| | nitrogen | 50.0% | 50.0% | 50.0% | 50.0% |
| | oxygen permeability of | 1000 | 1000 | 1000 | 1000 |
| | binder | | | | |
| | O2TRunder dry condition at | | | | |
| | 23° C. | | | | |
| | ml/atm/24r/m2 | | | | |
| | color of oxygen indicator | red | red | red | red |
| | (just after preparation) | | | | |
| | color of oxygen indicator | red | red | red | red |
| | (after one week) | | | | |
| | coloring time after release to | 4 hours | 4 hours | 4 hours | moment |
| | air | | | | |
| | color at the time of coloring | blue | brown | blue | blue |
| | light resistance test | three months or | three months or | three months or | three months or longer |
| | (fluorescent lamp 600 luxes, | longer | longer | longer | |
| | 20° C.) | | | | |

| | | | Comparative Example 1 |
|---|---|---|---|
| | | Example 11 | (US4526752) |
| pH of ink solution | | pH 10-11 | pH 10-11 |
| constitution | leuco dye | methylene blue | methylene blue |
| | redox potential | +0.5 V | +0.5 V |
| | | 0.2 g | (aqueous solution of 10 mM) |
| | | | 45 μL |
| | other dyes | not present | not present |
| | redox potential | | |
| | binder | nitrocellulose | methylcellulose |
| | | Mw = 5000 | Mw = 30000 |
| | content of binder wt % (relative | 12% | 5% |
| | to the amount of ink solution) | | |
| | reducing agent | ammonia | ammonia |
| | | 25% aqueous solution | 58% aqueous solution |
| | | 1 ml | 5 μL |
| | | (pH adjusted with sodium | ethanethiol |
| | | hydroxide) | 5 μL |
| | | reducing sugar | |
| | | 2.5 ml | |
| | | (10% aqueous solution) | |
| | solvent | water | water |
| | | 12 ml of isopropanol added | |
| | viscosity of ink composition | 90 | 300 |
| | @30° C. | | |
| | mPa · s | | |
| | coating thickness (μm) | | |
| printing conditions | temperature of printer head | 30° C. | 30° C. |
| packaging conditions | gas composition | | |
| | oxygen | 0% | |
| | carbon dioxide | 0% | |
| | nitrogen | 100% | |
| | deoxidant | present | |
| | (Wonder Keep RP200) | | |
| results | printed quantity | good (uneven) | bad (uneven) |
| | | much time is required for | much time is required for |
| | | drying | drying |
| | | sheet and corona treatment | not ejected from inkjet |
| | | capable of printing on PE | nozzle |
| | gas composition in package | | |
| | (after one day) | | |
| | oxygen | 0.0% | |
| | carbon dioxide | 0.1% | |
| | nitrogen | 99.9% | |
| | color of oxygen indicator | transparent | transparent |
| | (just after preparation) | | |
| | color of oxygen indicator | transparent | |
| | (after one day) | | |
| | coloring time after exposure to | one hour | |
| | air | | |
| | color at the time of coloring | blue | |
| | light resistance test | one week or shorter | |
| | (600 luxes, 20° C.) | | |

1. An ink composition comprising a redox compound as dye, a volatile agent as reducing agent, a polymer material as binder and a volatile solvent, wherein said ink composition has a viscosity of 3 to 150 mPas when said ink composition is used for printing.

2. A composition according to claim 1 having a viscosity of 10 to 40 mPas when it is used for printing.

3. An ink composition according to claim 1 wherein the binder content is 10 to 50 wt % based on the ink composition.

4. The ink composition according to claim 1 wherein the binder has a weight average molecular weight of 8000 or less.

5. A composition according to claim 1 wherein the binder is selected from the group consisting of a polyol, a ketone resin, a cellulose derivative and polyvinylpyrolidone.

6. An ink composition according to claim 1 wherein the binder comprises a cyclohexanone-derived ketone resin or an acetophenone-derived ketone resin.

7. An ink composition according to claim 1 wherein the binder comprises a mixture of a ketone resin, a resin acid and an ester compound from an alcohol.

8. An ink composition according to claim 7 wherein the resin acid is aleuretic acid, jalaric acid or laccijalaric acid.

9. A composition according to claim 1 wherein the volatile reducing agent is selected from the group consisting of an alcohol, ammonia, a thiol, an aldehyde and a low molecular amine.

10. An ink composition according to claim 1 wherein the volatile reducing agent is ammonia.

11. A composition according to claim 1 wherein the solvent is selected from the group consisting of an alcohol, a ketone, an ester and water.

12. An ink composition according to claim 1 wherein the redox agent as dye has a redox potential of 0.1 V or more.

13. A method for manufacturing an ink composition comprising mixing a redox agent as dye, a polymer material as binder and a volatile solvent, and then adding a volatile agent as reducing material to the resultant mixture and reducing the dye.

14. An oxygen indicator prepared by dripping the ink composition according to claim 1.

15. A method for manufacturing an oxygen indicator using dripping technique comprising dripping the ink composition according to claim 1, and then removing the volatile reducing agent and the volatile solvent.

16. An oxygen indicator according to claim 14 indicating a leakage and/or a change in oxygen content by color change.
